(19) United States
(12) Patent Application Publication
(10) Pub. No.: US 2011/0267014 A1
(43) Pub. Date: Nov. 3, 2011

(54) ELECTRICAL LOAD DRIVE DEVICE

(76) Inventor: Takayuki NAKAI, Osaka (JP)

(21) Appl. No.: 13/180,893

(22) Filed: Jul. 12, 2011

Related U.S. Application Data
(63) Continuation of application No. PCT/JP2009/005093, filed on Oct. 2, 2009.

(30) Foreign Application Priority Data
Jan. 14, 2009 (JP) 2009-005730

(51) Int. Cl. G05F 1/10

(52) U.S. Cl. 323/234

(57) ABSTRACT

An electrical load drive device can reduce the offset voltage without requiring means of initializing the charge of an integrating capacitance or a terminal for offset correction. The input selector of the electrical load drive device selects an input signal or no signal, and outputs an input selection signal. An integrator integrates the input selection signal and outputs the integrated signal. The load driver produces a load drive signal by pulse width modulation and amplification of the integrated signal. A first path is a path for feeding back the load drive signal. A second path is a path for feeding back the integrated signal. The path selector produces a feedback signal by selecting the first path or the second path. The offset correction signal generator produces an offset correction signal for adjusting the integrated signal so that the feedback signal offset decreases. The integrator adds and integrates the feedback signal with the input selection signal, and adjusts the integrated signal based on the offset correction signal.

### CROSS-REFERENCE TO RELATED APPLICATIONS

This is a continuation application of International Application No. PCT/JP2009/005093, filed Oct. 2, 2009 entitled “LOAD DRIVE DEVICE” and claims priority to Japanese Patent Application No. 2009-005730 filed Jan. 14, 2009, the content of which is incorporated by reference herein.

### BACKGROUND OF THE INVENTION

(1) Field of the Invention

The present invention relates to an electrical load drive device, and relates more particularly to an electrical load drive device having an offset adjustment function that reduces an output offset voltage.

(2) Description of Related Art

Electrical load drive devices that use pulse width modulation (PWM) to efficiently drive an electrical load are commonly used in the audio industry, for example, in speaker drivers that supply audio signals to speakers.

When the input signal is zero (0) in this electrical load drive device, an offset voltage is introduced to the final output voltage (the output offset voltage) of the system due to a mismatch in the device characteristics of the various circuit blocks, and undesirable popping sounds result. Japanese Patent Application Publication No. JP-A-2006-135904 discloses technology for suppressing this output offset voltage.

FIG. 9 is a block diagram of an electrical load drive device according to the related art. As shown in FIG. 9, switch 100p selects and outputs either the signal input from input terminal V1p or the voltage of the internal constant voltage node N1 to the input amplifier 101p.

The integrator 110p adds and integrates the output signal of the input amplifier 101p and the output signal of the feedback amplifier 120p. Inverter 132p outputs the inverted output signal of the integrator 110p. Comparator 133p compares the output signal of the integrator 110p and the output signal of the triangular wave generator 131p, and outputs the result. Similarly, comparator 134p compares the output signal of the inverter 132p and the output signal of the triangular wave generator 131p, and outputs the result.

The load driver 135p outputs an electrical load drive signal based on the output signal of the comparator 133p to output terminal V2p. Similarly, the load driver 136p outputs an electrical load drive signal based on the output signal of the comparator 134p to output terminal V3p.

The feedback amplifier 120p differentially amplifies and outputs the electrical load drive signals output from output terminals V2p and V3p to the integrator 110p.

The comparator 155p compares the output voltage of the integrator 110p and the voltage at reference voltage node N3p, and outputs the result.

The offset detection unit 151p receives the comparison signal from the comparator 155p and outputs an offset correction signal to the integrator 110p to correct the offset of the integrator 110p. Switch 114p shorts or opens the ends of the integrating capacitance 111p of the integrator 110p, and switches 153p and 154p short or open the reference voltage input terminal V100p and output terminals V2p and V3p.

The offset correction state and load driving state of the electrical load drive device according to the foregoing related art are described below.

In this example, the output of the load drivers 135p and 136p is controlled to a high impedance state before the offset correction state is entered. The switch 114p is closed and then opened again after the charge of the integrating capacitance 111p goes to 0. Switch 100p selects the internal constant voltage node Nip, and switches 153p and 154p close.

The offset correction state is described next. The comparator 155p compares the output voltage of the integrator 110p with the voltage at the reference voltage node N2p, and outputs the result. The offset detection unit 151p outputs an offset correction signal based on the result of the comparison, and reduces the offset voltage of the integrator 110p. The offset detection unit 151p repeats this operation until the sign of the offset voltage of the integrator 110p inverts, and when the sign of the offset voltage inverts, stops the offset correction operation and holds the offset correction signal at that time. The offset of the integrator 110p can therefore be held at the reduced level.

The load driving state is described next. In the load driving state the integrator 110p selects input terminal V1p and opens switches 153p and 154p. Electrical load driver 135p outputs a load drive signal based on the output signal of the comparator 133p to output terminal V2p. Electrical load driver 136p similarly outputs a load drive signal based on the output signal of the comparator 134p to output terminal V3p.

Input signal A1p is applied to input terminal V1p, and is amplified or attenuated to desirable amplitude by the input amplifier 101p. The input signal A1p output from the input amplifier 101p is input to one input terminal of the integrator 110p, and the load drive signals output from output terminals V2p and V3p are input to the other input terminal of the integrator 110p by the feedback amplifier 120p.

The integrator 110p adds and integrates the signals input to the one input terminal and the other input terminal of the integrator 110p, and outputs to the comparator 133p and the inverter 132p.

The inverter 132p inverts the output signal of the integrator 110p, and outputs to comparator 134p.

The triangular wave generator 131p outputs triangular wave signal Dp to comparators 133p and 134p for comparison with the other input signals.

Comparator 133p compares the two supplied input signals, and outputs pulse-width modulated signal E1p. Comparator 134p likewise compares the two supplied input signals, and outputs pulse-width modulated signal E2p.

The load driver 135p generates a load drive signal based on pulse-width modulated signal E1p, outputs to output terminal V2p, and supplies a drive signal to the load. Load driver 136p likewise generates a load drive signal based on pulse-width modulated signal E2p, outputs to output terminal V3p, and supplies a drive signal to the load.

The foregoing related art can thus suppress the output offset voltage of the system.

With the related art described above, the output of the pulse width modulation unit (also referred to as an electrical load driver) 130p is set to a high impedance state, the voltage of the reference voltage input terminal V100p is applied to the input of the feedback amplifier (also referred to as a signal attenuator) 120p, and the system forms an open loop in the offset correction state. In order to appropriately correct the offset, the charge of the integrating capacitance 111p of the integrator 110p must be driven to 0 by closing the switch 114p, that is, initialization is required. However, when the switch 114p is opened after being closed for initialization, the initial charge of the integrating capacitance 111p does not go to zero due to the effect of charge feed-through, for example. As a result, the offset correction operation is performed while a voltage equivalent to the initial charge of the integrating capacitance 111p is superimposed on the output offset voltage of the integrator 110p, and accurately correcting the offset is made more difficult. Another problem with the electrical load drive device according to the related art is that a reference voltage input terminal V100p is required for offset correction, and the footprint of the chip package thus increases.

### BRIEF SUMMARY OF THE INVENTION

An electrical load drive device according to the invention can reduce the offset voltage without requiring means of initializing the charge of the integrating capacitance and a terminal for offset correction, and thereby solves the foregoing problems of the related art.

An electrical load drive device according to the invention has an input selector that selects one of an input signal and no signal, and outputs an input selection signal representing the selected signal; an integrator that integrates the input selection signal and outputs an integrated signal; a load driver that generates a load drive signal that drives the load, said load drive signal being prepared by pulse-width modulation and amplification of the integrated signal; a first path that feeds back the load drive signal; a second path that feeds back the integrated signal; a path selector that selects one of the first path and the second path, and generates a first feedback signal based on the selected one of the load drive signal and the integrated signal; and an offset correction signal generator that generates an offset correction signal for adjusting the integrated signal so that the offset of the first feedback signal decreases; wherein the integrator adds and integrates the first feedback signal with the input selection signal, and adjusts the integrated signal based on the offset correction signal.

### Effect of the Invention

By providing a path selector that selects a first path or a second path, the electrical load drive device according to the invention can always form a closed loop through the path selector and the integrator. As a result, means for initializing the integrating capacitance and an external input terminal for offset correction can be omitted. As a result, a highly accurate offset correction operation is possible, and the offset can be sufficiently reduced.

### BRIEF DESCRIPTION OF THE SEVERAL VIEWS OF THE DRAWINGS

FIG. 1 is a block diagram of an electrical load drive device according to a first embodiment of the invention.

FIG. 2 is a block diagram of an electrical load drive device according to a second embodiment of the invention.

FIG. 3 is a block diagram of an electrical load drive device according to a third embodiment of the invention.

FIG. 4 is a block diagram of an electrical load drive device according to a fourth embodiment of the invention.

FIG. 5 is a block diagram of an electrical load drive device according to a fifth embodiment of the invention.

FIG. 6 is a block diagram of an electrical load drive device according to a sixth embodiment of the invention.

FIG. 7 is a block diagram of an electrical load drive device according to a seventh embodiment of the invention.

FIG. 8 is a block diagram of an electrical load drive device according to an eighth embodiment of the invention.

FIG. 9 is a block diagram of an electrical load drive device according to the related art.

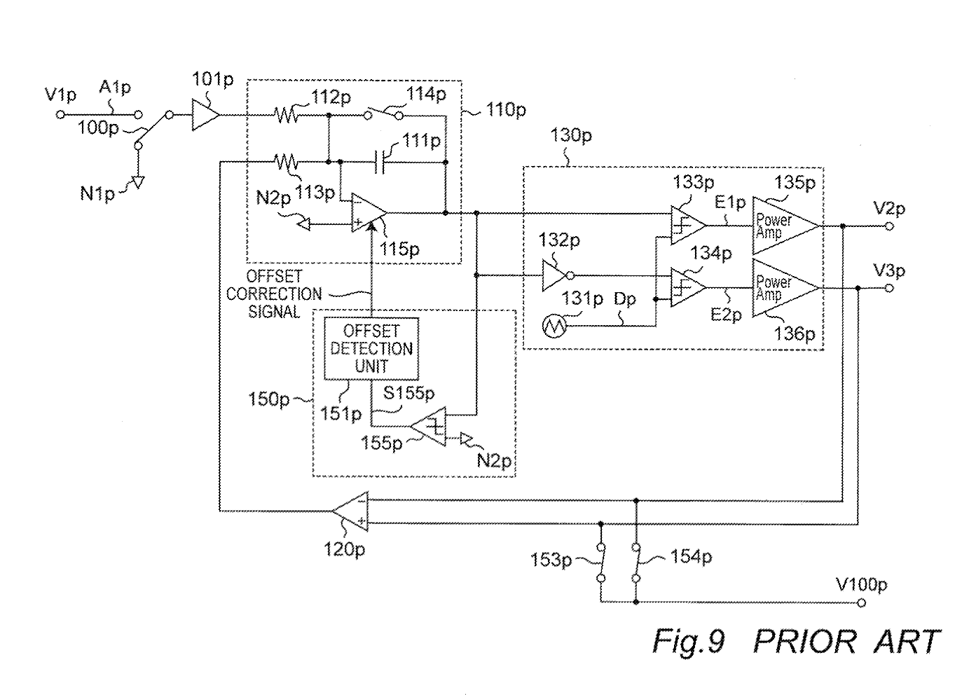

### DETAILED DESCRIPTION OF THE INVENTION

Preferred embodiments of the present invention are described below with reference to the accompanying figures. Note that elements having the same configuration, operation, and effect are identified in the figures by the same reference numerals. In addition, numbers in the following embodiments are used to specifically describe particular aspects of the invention, and the invention is not limited to the numbers used below. In addition, logic levels denoted by high/low, and switching states denoted as on/off are also used to describe specific aspects of the invention by way of example, and equivalent results can be achieved using different combinations of the logic levels and switching states described below. Connections between different components are also shown by way of example to describe specific aspects of the invention, and the connections required to achieve the function of the invention are not limited thereto. Yet further, the following embodiments are rendered using hardware and/or software components, but functions rendered by hardware can also be rendered using software, and functions rendered by software below can also be rendered using hardware.

### Embodiment 1

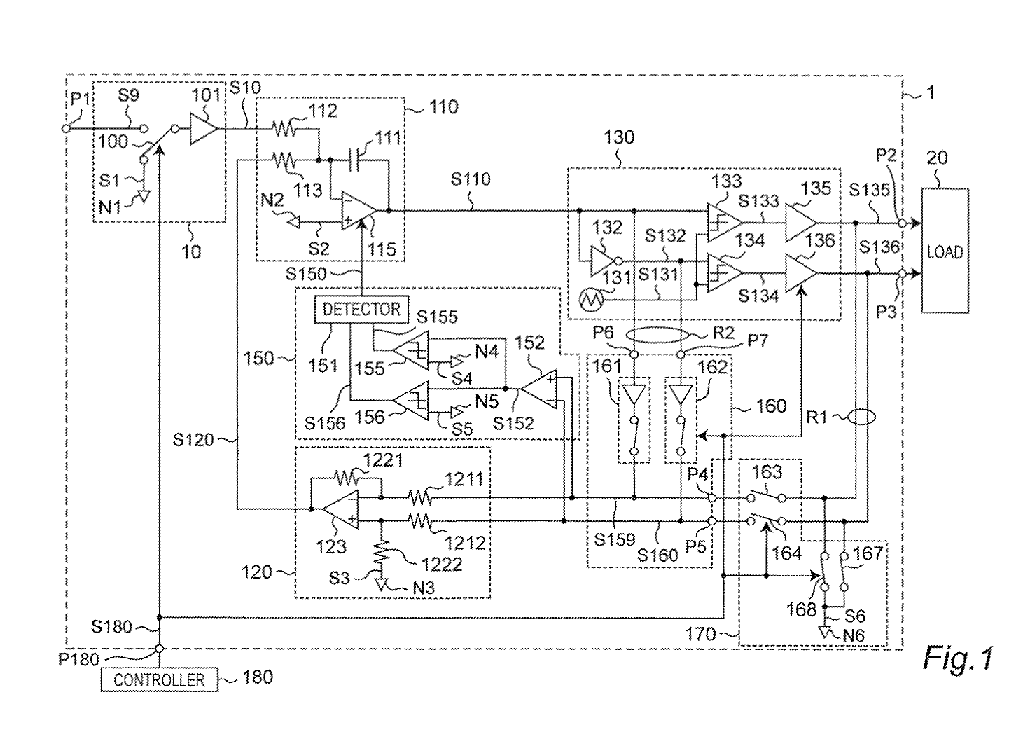

The configuration of an electrical load drive device 1 according to a first embodiment of the invention is described below with reference to FIG. 1.

As shown in FIG. 1, the electrical load drive device 1 includes an input selector 10, integrator 110, load driver 130, path R1, path R2, path selector 160, signal attenuator 120, offset correction signal generator 150, reverse-current suppressor 170, pin P1, pin P2, pin P3, and pin P180. In addition to the electrical load drive device 1, an electrical load 20 and controller 180 are also shown in FIG. 1.

The input selector 10 includes a switch 100, voltage node N1, and amplifier 101.

The integrator 110 includes a resistor 112, resistor 113, voltage node N2, amplifier 115, and integrating capacitance 111.

The load driver 130 includes an inverter 132, triangular wave generator 131, comparator 133, comparator 134, driver 135, and driver 136.

The path selector 160 includes an amplifier 161 and amplifier 162.

The signal attenuator 120 includes a resistor 1211, resistor 1212, resistor 1221, resistor 1222, voltage node N3, and amplifier 123.

The offset correction signal generator 150 includes a difference signal generator 152, voltage node N4, voltage node N5, comparator 155, comparator 156, and detector 151.

The reverse-current suppressor 170 includes a switch 163, switch 164, switch 168, switch 167, and voltage node N6.

The electrical load drive device 1 generates pulse-width modulated load drive signals S135, S136 based on the input signal S9 received through pin P1, and outputs through pins P2 and P3 to the load 20. The input signal S9 is, for example, an audio signal with a frequency range from 20 Hz to 20 kHz, and the time-based average of the input signal S9 is substantially 0. More specifically, the DC component of the input signal S9 is substantially 0. The load 20 includes a low pass filter that cuts off the unnecessary high frequency component of the load drive pulse signals S135, S136, and a speaker. The low pass filter can be omitted in some applications.

The electrical load drive device 1 is controlled based on the control signal S180 received from the controller 180 through pin P180. The operating states of the electrical load drive device 1 include a load drive state in which the electrical load drive device 1 is driving the load 20, and an offset correction state for correcting the offset of the load drive signals S135, S136 (more specifically, a state for correcting the offset of the feedback signals S159, S160 described below).

The electrical load drive device 1 is set to the load drive state, or mode, when the control signal S180 is high, and is set to the offset correction state, or mode, when the control signal S180 is low.

### Load Drive State

The configuration and operation of the electrical load drive device 1 in the load drive state are described first below.

The controller 180 sets the control signal S180 to high, and sets the electrical load drive device 1 to the load drive state. The input selector 10 selects input signal S9 received through pin P1 or the specific voltage S1 at voltage node N1 by means of switch 100, and outputs an input selection signal S10 indicating which signal was selected. This specific voltage S1 is the ground voltage, for example, and is referred to herein as non-signal S1. More specifically, when the control signal S180 goes high, the switch 100 selects the input signal S9. The amplifier 101 amplifies the selected input signal S9, and outputs the input selection signal S10.

The integrator 110 adds and integrates the feedback signal S120 described below with the input selection signal S10, and outputs integrated signal S110. More specifically, the integrator 110 adds the feedback signal S120 to the input selection signal S10 by receiving the feedback signal S120 through resistor 113 simultaneously to receiving the input selection signal S10 through resistor 112. The amplifier 115 receives the combined signal at the inverted input terminal, receives the specific voltage S2 at voltage node N2, and integrates the input signals using the inverted input terminal and the integrating capacitance 111 connected to the output node. The specific voltage S2 is the ground voltage, for example. The amplifier 115 is, for example, a differential amplifier that amplifies the difference of the signal input to the non-inverted input terminal minus the signal input to the inverted input terminal.

The load driver 130 pulse-width modulates and amplifies the integrated signal S110 to produce load drive signal S135 and load drive signal S136 for driving the load 20. More specifically, the load driver 130 includes an inverter 132, and the inverter 132 inverts the integrated signal S110 and outputs inverted integrated signal S132. For example, the DC level of the integrated signal S110 and the inverted integrated signal S132 is near the ground voltage, that is, is within a specific range including the ground voltage. The absolute value of the DC level of the inverted integrated signal S132 is substantially equal to the DC level of the integrated signal S110, but the sign is reversed.

The load driver 130 produces load drive signals S135, S136 on two channels by pulse-width modulation and amplification of the integrated signal S110 while simultaneously pulse-width modulating and amplifying inverted integrated signal 5132.

More specifically, the triangular wave generator generates triangular wave signal S131. The DC level of the triangular wave signal S131 is the ground voltage, for example.

The comparator 133 compares integrated signal S110 with triangular wave signal S131, and outputs comparison result signal comparison result 3D signal S133. Comparator 134 compares inverted integrated signal S132 and the triangular wave signal S131, and outputs comparison result signal S134. Comparison result signals S133, S134 are, respectively, the results of pulse-wave modulating integrated signal S110 and inverted integrated signal S132 using the triangular wave signal S131.

The driver 135 amplifies comparison result signal S133, and outputs a load drive signal S135 with sufficient amplitude to drive the load 20.

Driver 136 similarly amplifies comparison result signal S134 and outputs a load drive signal S136 with sufficient amplitude to drive the load 20. The DC level of load drive signals S135, S136 is near the ground voltage level, or more specifically is within a specific range including the ground voltage.

Path R1 is the feedback path of the two load drive signals S135, S136. More specifically, path R1 denotes a two-channel path including a path from the output terminal of the driver 135 (actually the same as pin P2) to the input node P4 of the path selector 160, and the path from the output terminal of the driver 136 (actually pin P3) to the input node P5 of the path selector 160.

Path R2 is the feedback path of the integrated signal S110 and inverted integrated signal S132. More specifically, path R2 is a two-channel path including the path from the output terminal of the integrator 110 to the input node P6 of the path selector 160, and the path from the output terminal of inverter 132 to the input node P7 of the path selector 160.

The path selector 160 outputs feedback signal S159 based on the load drive signal S135 or integrated signal S110 by selecting either path R1 or path R2. The path selector 160 also outputs feedback signal S160 based on the load drive signal S136 or inverted integrated signal S132 by selecting either path R1 or path R2.

When the control signal S180 is high, the path selector 160 selects path R1, and feedback signals S159, S160 are output based on load drive signals S135, S136.

The reverse-current suppressor 170 suppresses reverse current flow to the path R1 of the integrated signal S110 and inverted integrated signal S132.

The amplifier 161 has a switch, is connected to input node P6, amplifies integrated signal S110, and either passes or blocks output of the amplified signal. The amplifier 162 has a switch, is connected to input node P7, amplifies inverted integrated signal S132, and either passes or blocks output of the amplified signal. When the control signal S180 is high, amplifiers 161, 162 turn off and block output of integrated signal S110 and inverted integrated signal S132, respectively.

Switch 163 is connected to input node P4, and passes or blocks load drive signal S135. Switch 164 is connected to input node P5, and passes or blocks load drive signal S136.

When the control signal S180 is high, switches 163, 164 turn on and pass load drive signals S135, S136, respectively. Switches 168, 167 are connected to pin P2, P3, respectively, and set path R1 to a specific voltage. More specifically, when the control signal S180 is high, switches 168, 167 turn off and isolate path R1 from voltage node N6.

The signal attenuator 120 attenuates the two feedback signals S159, S160 and converts to a single feedback signal S120. For example, the amplifier 123 is a differential amplifier, and the specific voltage S3 at voltage node N3 is the ground voltage. If the voltage of feedback signals S159, S160, S120 is V159, V160, V120, respectively; the resistance of resistors 1211, 1212, 1221, 1222 is R1211, R1212, R1221, R1222, respectively; and

R1221/R1211=R1222/R1212=FR, (1)

then

V120=−FR×(V159−V160). (2)

Note that resistances R1221, R1222 are respectively lower than resistances R1211, R1212. More specifically, ratio FR is set to less than 1, and feedback signal S120 is attenuated from feedback signals S159, S160. More specifically, ratio FR is set to less than or equal to the inverse of the ratio of load drive signals S135, S136 to input selection signal S10.

As a result, the signal attenuator 120 attenuates the feedback signal S159 minus feedback signal S160 by ratio FR, inverts the sign, and outputs feedback signal S120. The feedback signal S120 is therefore the inverse sign of and substantially proportional to integrated signal S110. As described above, the integrator 110 adds and integrates the feedback signal S120 with the input selection signal S10. When the control signal S180 is high, the integrator 110, load driver 130, path R1, path selector 160, and signal attenuator 120 form a closed loop of the electrical load drive device 1 in the load drive state. In this loop the path from path R1 through the path selector 160 and signal attenuator 120 to the integrator 110 denotes the negative feedback path of the electrical load drive device 1 in the load drive state. This negative feedback path improves the linearity, frequency characteristic, and distortion characteristic of the load drive signals S135, S136, and can minimize the negative effects of supply voltage variations.

### Offset Correction State

The configuration and operation of the electrical load drive device 1 in the offset correction state are described next.

The controller 180 sets the electrical load drive device 1 to the offset correction state when the controller 180 power turns on, such as when the operating state changes from the radio to a Compact Disc (CD (R)) or when a CD is loaded. Note that in case of an emergency, for example, the controller 180 may quickly switch the electrical load drive device 1 from the load drive state to the offset correction state while audio is output from the radio, and then return to the load drive state.

The controller 180 sets the control signal S180 low, and sets the electrical load drive device 1 to the offset correction state. When the control signal S180 is low, the switch 100 selects non-signal S1. The amplifier 101 amplifies the selected non-signal S1 and outputs integrated signal S110. The integrator 110 adds and integrates the feedback signal S120 with the input selection signal S10, and outputs integrated signal S110. The inverter 132 inverts integrated signal 5110 and outputs inverted integrated signal S132. When control signal S180 is low, the driver 135 sets the load drive signal S135 to a high impedance state, and interrupts supply to pin P2. Likewise, when control signal S180 is low, driver 136 sets load drive signal S136 to a high impedance state and interrupts supply to pin P3.

When control signal S180 is low, the path selector 160 generates feedback signals S159, S160 based on the integrated signal S110 and inverted integrated signal S132 by selecting path R2. When control signal S180 is low, amplifiers 161, 162 turn on and pass integrated signal S110 and inverted integrated signal S132, respectively.

The path selector 160 thus outputs feedback signals S159, S160 based on load drive signals S135, S136, respectively, by turning amplifiers 161, 162 on when control signal S180 is high. When control signal S180 is low, the path selector 160 sets the load drive signals S135, S136 to a high impedance state, and thereby generates feedback signals S159, S160 based on the integrated signal S110 and inverted integrated signal S132. More specifically, while not shown in the figure, the path selector 160 includes a function for setting the load drive signals S135, S136 to a high impedance state.

Note that when the path selector 160 selects path R2, path R1 can be isolated using switches 163, 164 with setting the load drive signals S135, S136 to a high impedance state.

The difference between feedback signal S159 and feedback signal S160 in the offset correction state represents the amount of offset to be corrected. The size and offset of the feedback signals S159, S160 in the offset correction state is preferably equal to the size and offset of the load drive signals S135, S136 when there is no input signal S9 in the load drive state. As a result, the gain of the amplifier 161 is preferably equal to the gain of the comparator 133 and driver 135 combined. Likewise, the gain of the amplifier 162 is preferably equal to the combined gain of the comparator 134 and driver 136.

When the control signal S180 is low, the reverse-current suppressor 170 suppresses the integrated signal S110 and the inverted integrated signal S132 to flow into the path R1, as a reverse current flow. By turning switch 163 off when the control signal S180 is low, the feedback signal S159 is prevented from flowing, in reverse, to pin P2, and feedback signal S160 is prevented from flowing, in reverse, to pin P3 by turning switch 164 off. When control signal S180 is low, switches 168, 167 both turn on and supply the specific voltage at voltage node N6 through pin P2 and pin P3, respectively, to the load 20. The specific voltage at voltage node N6 is the ground voltage, for example.

As a result, when control signal S180 is high, load drive signals S135, S136 are supplied to the load 20, and when control signal S180 is low, the ground potential is supplied to the load 20.

The signal attenuator 120 attenuates and converts the two channel feedback signals S159, S160 to a one-channel feedback signal S120. The integrator 110 adds and integrates the feedback signal S120 with the input selection signal S10. When the control signal S180 is low, the integrator 110, path R2, path selector 160, and signal attenuator 120 form a closed loop when the electrical load drive device 1 is in the offset correction state.

The path from path R2 through the path selector 160 and signal attenuator 120 to the integrator 110 represents the negative feedback path of the electrical load drive device 1 in the offset correction state.

As in the load drive state in the offset correction state, the electrical load drive device 1 has a negative feedback path through the path selector 160 and signal attenuator 120. Operation can therefore continue without changing the configuration when the integrator 110 changes from the load drive state to the offset correction state.

The offset correction signal generator 150 generates an offset correction signal S150 for adjusting the integrated signal S110 to reduce the offset between feedback signals S159, S160. The integrator 110 adjusts the integrated signal S110 based on the offset correction signal S150. For example, the integrator 110 adjusts the DC level of the integrated signal S110 based on the offset correction signal S150. The inverter 132 outputs the adjusted inverted integrated signal S132 based on the adjusted integrated signal S110. The path selector 160 produces adjusted feedback signals S159, S160 based on the adjusted integrated signal S110 and adjusted inverted integrated signal 5132, respectively. The offset of the adjusted feedback signals S159, S160 is smaller than before adjustment.

In the offset correction signal generator 150, the difference signal generator 152 produces difference signal S152 by subtracting feedback signal S160 from feedback signal S159.

The difference signal generator 152 is, for example, a differential amplifier that receives feedback signal S159 at the non-inverted input terminal and feedback signal S160 at the inverted input terminal, amplifies the difference of feedback signal S159 minus feedback signal S160, and outputs difference signal S152. Difference signal S152 is the amplified offset of feedback signals S159, S160.

Comparator 155 compares difference signal S152 with a specific comparison voltage S4 at voltage node N4, and outputs comparison result signal S155. Comparator 156 compares difference signal S152 with the specific comparison voltage S5 at voltage node N5, and outputs comparison result signal S156. The value of comparison voltage S5 may differ from comparison voltage S4.

The detector 151 generates the offset correction signal S150 based on comparison result signals S155, S156 to reduce the size of difference signal S152, that is, to reduce the offset between feedback signals S159, S160.

### Operation of the Offset Correction Signal Generator 150

A specific example of the operation of the offset correction signal generator 150 is described next.

If comparison voltages S4 and S5 are voltages V4 and V5, respectively, and the difference signal S152 voltage is VOFF, and

V4>V5 (3)

the relationship between voltage VOFF and voltages V4, V5 is described by the three equations (4), (5), and (6) below.

V4>VOFF>V5 (4)

VOFF>V4>V5 (5)

V4>V5>VOFF (6)

If a voltage of 0 volts is V0, and voltage VOFF has a voltage difference dVOFF to voltage V0, then

VOFF=V0+dVOFF (7)

is true. In addition, if voltages V4, V5 are voltages of opposite sign that differ from voltage V0 by voltage Vlimit, then

V4=V0+Vlimit (8)

V5=V0−Vlimit (9)

are true. Using equations 7 to 9, statements 4 to 6 can be rewritten as follows.

+Vlimit>dVOFF>−Vlimit (10)

dVOFF>+Vlimit>−Vlimit (11)+

Vlimit>−Vlimit>dVOFF (12)

The offset of the feedback signals S159, S160 in the offset correction state is desirably within tolerance VD (that is, a range from voltage −VD to voltage +VD). If the voltage gain of the difference signal generator 152 is G152, voltage Vlimit is the following.

Vlimit=G152×VD (13)

If equation 10, that is, equation 4, is satisfied in this case, the detector 151 stops the offset correction operation. The detector 151 generates the offset correction signal S150 based on the comparison result signal S155, which takes the three values shown in equations 4 to 6, so that the offset is within tolerance VD. Although not shown in the figure, when the detector 151 stops the offset correction operation, it also reports to the controller 180 that the offset correction operation stopped. Based on this report, the controller 180 changes the control signal S180 from low to high.

The steps executed by the detector 151 in the offset correction state are described next. When voltage VOFF is as shown in equation 5, voltage VOFF is greater than voltage V4, and the detector 151 therefore changes the offset correction signal S150 to lower voltage VOFF. When voltage VOFF is as shown in equation 6, voltage VOFF is less than voltage V5, and the detector 151 therefore changes the offset correction signal S150 to increase voltage VOFF. By repeating these steps, the detector 151 stops the offset correction operation when voltage VOFF satisfies equation 4.

A configuration in which the detector 151 uses a binary search method is described next.

In this example the offset correction signal S150 is 5 bits, has 15 levels (4 bits) each on the high and low sides, and the most-significant bit is a 1-bit sign bit (0 indicating high, and 1 low). When the offset correction signal S150 changes only one level, voltage VOFF changes by only voltage Vadj.

Voltage VOFF at the start of the offset correction state is voltage VOFF(0). The detector 151 compares voltages VOFF(0), V4, and V5, and determines the sign bit. For example, if voltage VOFF satisfies equation 5, the detector 151 sets the sign bit to 1 and proceeds to determine the remaining four bits.

The detector 151 then adjusts bit 3 of the remaining four bits (where the bits are labeled bits 1 to 4 from the least significant bit) as follows

VOFF=VOFF(0)−4×Vadj (14)

and compares voltage VOFF with voltages V4 and V5.

The detector 151 then repeats the same process using bit 2 and bit 1, stops the offset correction operation when voltage VOFF satisfies equation 4, and holds the offset correction signal S150 resulting from the offset correction operation.

By using satisfaction of equation 4 as the condition for stopping the offset correction operation, the offset correction operation using comparators 155 and 156 can prevent overcorrecting the offset amount and is extremely well-suited to binary search techniques.

The offset voltage of selected components in the offset correction state is described next. First, the gain of the amplifier 115 in the integrator 110 is set sufficiently high. The input offset voltage of the amplifier 115 is V115, the resistance of resistors 112 and 113 is R112 and R113, respectively, and the offset voltage produced in the inverter 132 and amplifiers 161, 162 is V132. The input offset voltage of the amplifier 123 in the signal attenuator 120 is V123; the resistance of both resistors 1211, 1212 is R121; and the resistance of both resistors 1221, 1222 is R122. In this case, the offset voltage VOFF of feedback signals S159, S160 in the offset correction state, that is, the potential difference VOFF of the input pin of the signal attenuator 120, is as shown in equation 15. Note that the three characters following the first letter of VOFF, R121, R122, R113, R112, V115, and V123 are used as the right indices of the values below.

$${V}_{OFF} = \frac{{R}_{121}}{{R}_{122}} ( 1 + \frac{{R}_{113}}{{R}_{112}} ) {V}_{115} + ( 1 + \frac{{R}_{121}}{{R}_{122}} ) {V}_{123} \qquad ( 15 )$$

As equation (15) shows, only the integrator 110 and signal attenuator 120 affect the offset voltage VOFF, and the inverter 132 and amplifiers 161, 162 do not affect the offset voltage.

The same description applies to the offset voltage of the feedback signals S159, S160 in the load drive signal. More specifically, the offset voltage V132 produced by the inverter 132 and the amplifiers 161, 162 in the offset correction state described above is replaced by the offset voltage V130 produced by the inverter 132, comparators 133, 134, and drivers 135, 136. However, like offset voltage V132, offset voltage V130 has no effect on equation (15). The offset voltage VOFF in the load drive signal is also obtained by equation (15).

As described above, by using a path selector 160 that selects path R1 or path R2, the electrical load drive device 1 according to the first embodiment of the invention can always form a closed loop through the path selector 160, signal attenuator 120, and integrator 110. More specifically, the path selector 160 selects path R1 when operation is controlled to a load drive state in which a load 20 is driven, and selects path R2 when controlled to the offset correction state denoting the state for correcting the offset of feedback signals S159, S160.

The electrical load drive device 1 has a negative feedback path from the path selector 160 through the signal attenuator 120 to the integrator 110 in both the load drive state and offset correction state. As a result, the integrator 110 can continue operating without reconfiguring when operation switches from the load drive state to the offset correction state. As a result, a configuration for initializing the integrating capacitance 111, and an external input terminal for offset correction, can be omitted. A highly accurate offset correction operation can therefore be achieved, and the offset can be sufficiently reduced.

In the offset correction signal generator 150, the difference signal generator 152 can detect the offset by amplifying the small voltage offset between feedback signals S159, S160, and output difference signal S152. Comparators 155, 156 use comparison voltages S4, S5, respectively, and the detector 151 determines which of the three voltage ranges separated by the mutually different comparison voltages S4 and S5 contains the difference signal S152. Because the detector 151 stops the offset correction operation if the difference signal S152 is between comparison voltage S4 and S5, excessive offset correction of the offset can be prevented and the accuracy of the offset correction can be further improved.

The reverse-current suppressor 170 blocks or suppresses reverse current flow to the path R1 of integrated signal S110 and inverted integrated signal S132. The reverse-current suppressor 170 includes switches 163, 164, and switches 163, 164 interrupt path R1 when set to the offset correction state based on control signal S180. As a result, the reverse-current suppressor 170 can preventing sound pops in the offset correction state.

Alternatively, the reverse-current suppressor 170 may use resistors 165, 166 instead of switches 163, 164. By desirably setting the resistance of resistors 165, 166, sound pops in the offset correction state can be suppressed and the circuitry can be simplified.

When the reverse-current suppressor 170 has switches 168 and 167, and switches 168 and 167 are set to the offset correction state based on control signal S180, the switches turn on and set the path R1 to a specific voltage. As a result, sound pops caused by leakage current from the drivers 135, 136 in a high impedance state when changing from the offset correction state to the load drive state can be suppressed.

In addition, the load drive signals S135, S136 of the electrical load drive device 1 must be high amplitude signal's sufficiently capable of driving the load 20, and the feedback signals S159, S160 are therefore also high amplitude signals. As a result, the drive voltage of the electrical load drive device 1 may be set high for the drivers 135 and 136, amplifiers 161 and 162, difference signal generators 152, and signal attenuator 120, and set relatively low for other circuits. As a result, the electrical load drive device 1 can balance high amplitude output of the load drive signals S135, S136 with low power consumption.

### Embodiment 2

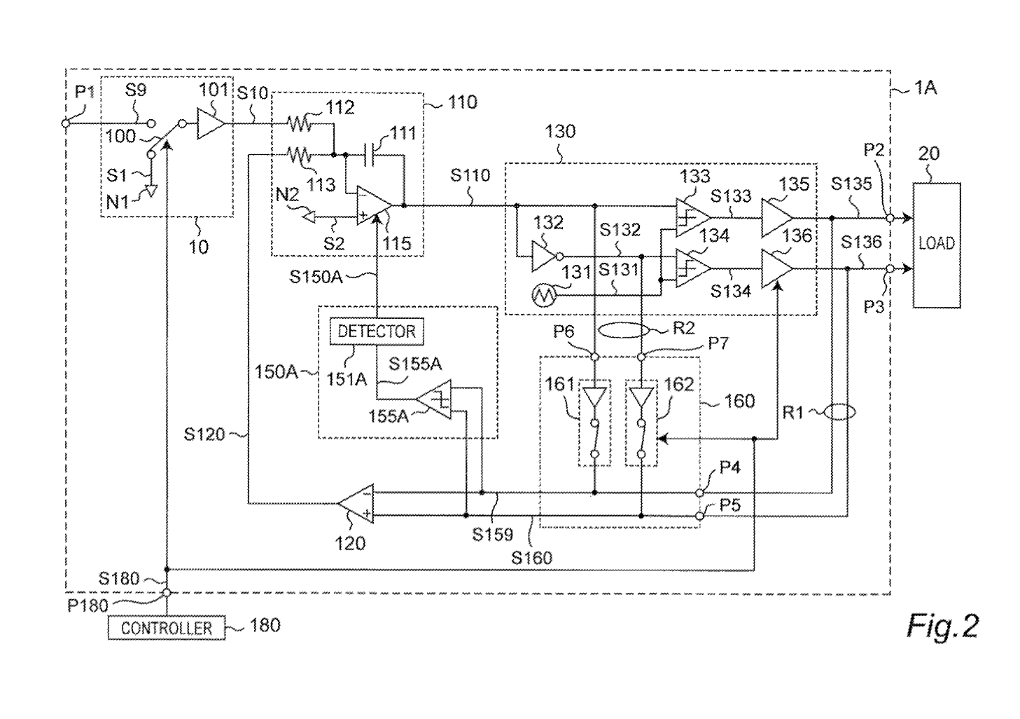

FIG. 2 is a block diagram of an electrical load drive device 1A according to a second embodiment of the invention. This electrical load drive device 1A differs from the electrical load drive device 1 according to the first embodiment of the invention in that offset correction signal generator 150 is changed to offset correction signal generator 150A, and the reverse-current suppressor 170 is omitted.

Note further that in FIG. 2 the signal attenuator 120 is identical to the signal attenuator 120 in FIG. 1, but is shown simplified in FIG. 2 to FIG. 8.

Other aspects of the configuration, operation, and effect of this embodiment are identical to the electrical load drive device 1 described above, and further description thereof is omitted below.

The offset correction signal generator 150A includes a comparator 155A and detector 151A. The offset correction signal generator 150A outputs offset correction signal S150A for adjusting the integrated signal S110 to reduce the offset between feedback signals S159, S160. The integrator 110 adjusts the integrated signal S110 based on offset correction signal S150A.

In the offset correction signal generator 150A, the comparator 155A compares feedback signal S159 and feedback signal S160, and outputs comparison result signal S155A. Based on the comparison result signal S155A, the detector 151A produces offset correction signal S150A to reduce the offset between feedback signals S159, S160.

As a result, the electrical load drive device 1A can simplify the hardware or software configuration of the offset correction signal generator 150A compared with the offset correction signal generator 150 described above, and the hardware used for the reverse-current suppressor 170 can be omitted.

### Embodiment 3

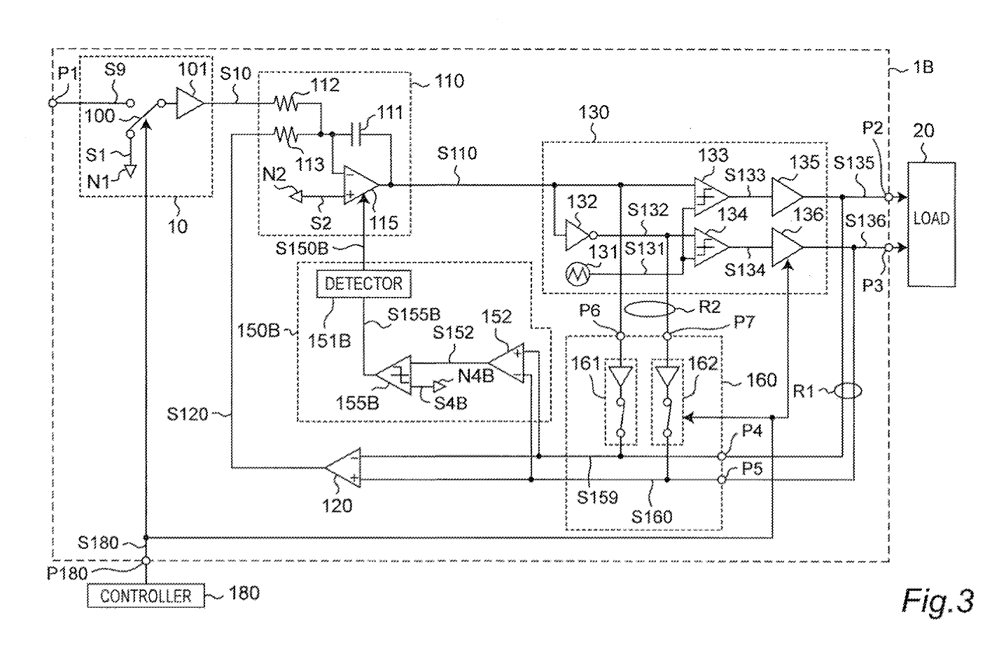

FIG. 3 is a block diagram of an electrical load drive device 1B according to a third embodiment of the invention. This electrical load drive device 1B differs from the electrical load drive device 1 according to the first embodiment of the invention in that offset correction signal generator 150 is changed to offset correction signal generator 150B, and the reverse-current suppressor 170 is omitted.

Other aspects of the configuration, operation, and effect of this embodiment are identical to the electrical load drive device 1 described above, and further description thereof is omitted below.

The offset correction signal generator 150B includes a difference signal generator 152, voltage node N4B, comparator 155B, and detector 151B. The offset correction signal generator 150B produces an offset correction signal S150B for adjusting the integrated signal S110 to reduce the offset between feedback signals S159, S160. The integrator 110 adjusts the integrated signal S110 based on offset correction signal S150B.

The difference signal generator 152 of the offset correction signal generator 150B outputs difference signal S152 denoting the difference of feedback signal S159 minus feedback signal S160.

The comparator 155B compares this difference signal S152 with the specific comparison voltage S4B at voltage node N4B, and outputs comparison result signal S155B.

Based on the comparison result signal S155B, the detector 151B produces offset correction signal S150B to reduce the offset between feedback signals S159, S160.

With this configuration, the electrical load drive device 1B can simplify the hardware or software configuration of the offset correction signal generator 150B compared with the offset correction signal generator 150 described above, and the hardware used for the reverse-current suppressor 170 can be omitted.

### Embodiment 4

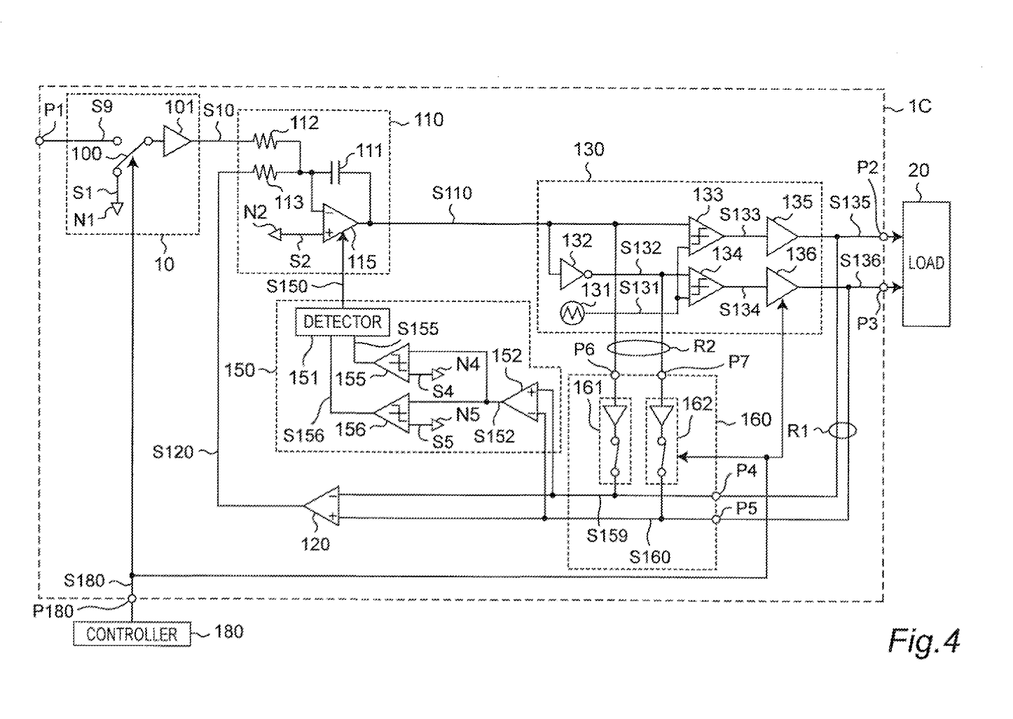

FIG. 4 is a block diagram of an electrical load drive device 1C according to a fourth embodiment of the invention. This electrical load drive device 1C differs from the electrical load drive device 1 according to the first embodiment of the invention in that the reverse-current suppressor 170 is omitted.

Other aspects of the configuration, operation, and effect of this embodiment are identical to the electrical load drive device 1 described above, and further description thereof is omitted below.

With this configuration, the electrical load drive device 1C can omit the hardware used for the reverse-current suppressor 170.

### Embodiment 5

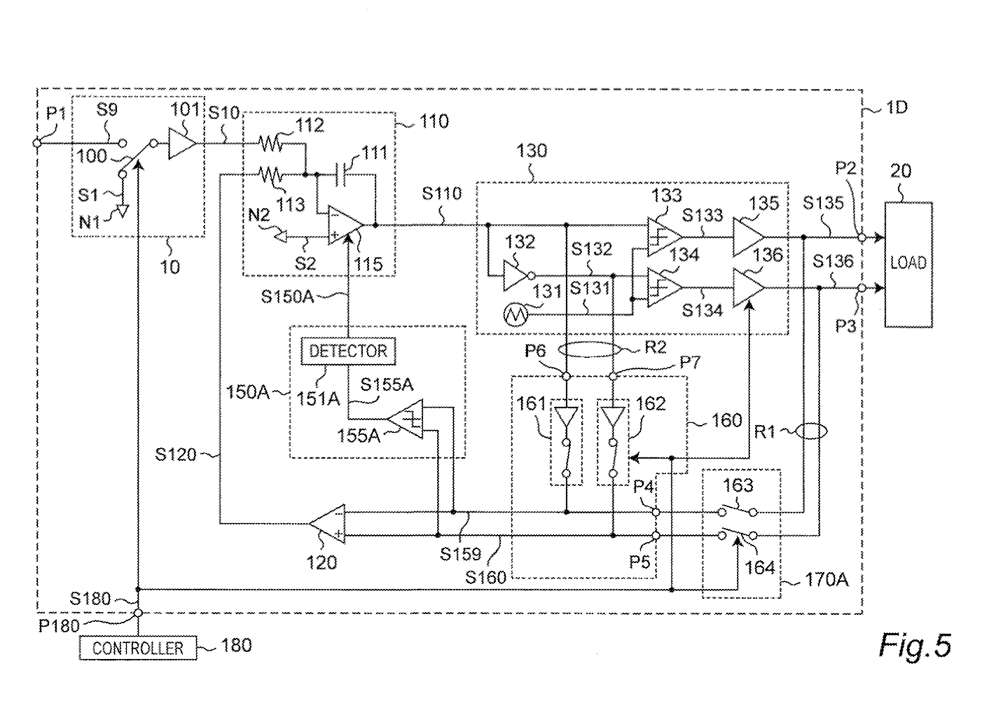

FIG. 5 is a block diagram of an electrical load drive device 10 according to a fifth embodiment of the invention. This electrical load drive device 1D differs from the electrical load drive device 1 according to the first embodiment of the invention in that offset correction signal generator 150 is changed to offset correction signal generator 150A, and the reverse-current suppressor 170 is changed to reverse-current suppressor 170A.

Other aspects of the configuration, operation, and effect of this embodiment are identical to the electrical load drive device 1 described above, and further description thereof is omitted below.

The reverse-current suppressor 170A includes switch 163 and switch 164, and does not include switch 168, switch 167, and voltage node N6 that are used in reverse-current suppressor 170.

Reverse-current suppressor 170A suppresses reverse current flow to the path R1 of integrated signal S110 and inverted integrated signal S132. When the control signal S180 is low, the reverse-current suppressor 170A suppresses reverse current flow to the path R1 of the integrated signal S110 and inverted integrated signal S132. Feedback signal S159 is prevented from flowing in reverse to the pin P2 by turning switch 163 off when the control signal S180 is low, and feedback signal S160 is prevented from flowing in reverse to pin P3 by turning switch 164 off.

With this configuration, the electrical load drive device 1D can simplify the hardware or software configuration of the offset correction signal generator 150A compared with the offset correction signal generator 150 described above, and the hardware configuration of the reverse-current suppressor 170A can be simplified compared with the foregoing reverse-current suppressor 170.

### Embodiment 6

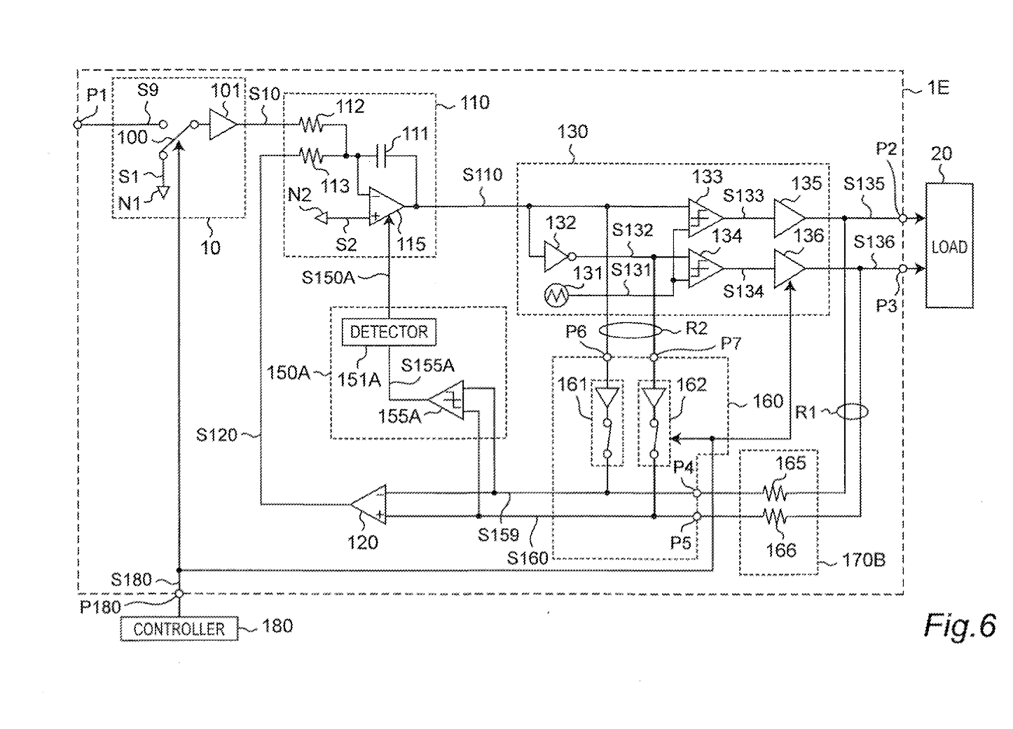

FIG. 6 is a block diagram of an electrical load drive device 1E according to a sixth embodiment of the invention. This electrical load drive device 1E differs from the electrical load drive device 1 according to the first embodiment of the invention in that offset correction signal generator 150 is changed to offset correction signal generator 150A, and the reverse-current suppressor 170 is changed to reverse-current suppressor 170B.

Other aspects of the configuration, operation, and effect of this embodiment are identical to the electrical load drive device 1 described above, and further description thereof is omitted below.

The reverse-current suppressor 170B has resistor 165 and resistor 166, and does not have the switch 168, switch 167, and voltage node N6 of reverse-current suppressor 170. The reverse-current suppressor 170A suppresses reverse current flow to the path R1 of the integrated signal S110 and inverted integrated signal S132. When the control signal S180 is low, the reverse-current suppressor 170A suppresses reverse current to the path R1 of integrated signal S110 and inverted integrated signal S132. As a result, the hardware configuration of the reverse-current suppressor 170B in the electrical load drive device 1E according to this embodiment of the invention can be simplified compared with the reverse-current suppressor 170 described above.

### Embodiment 7

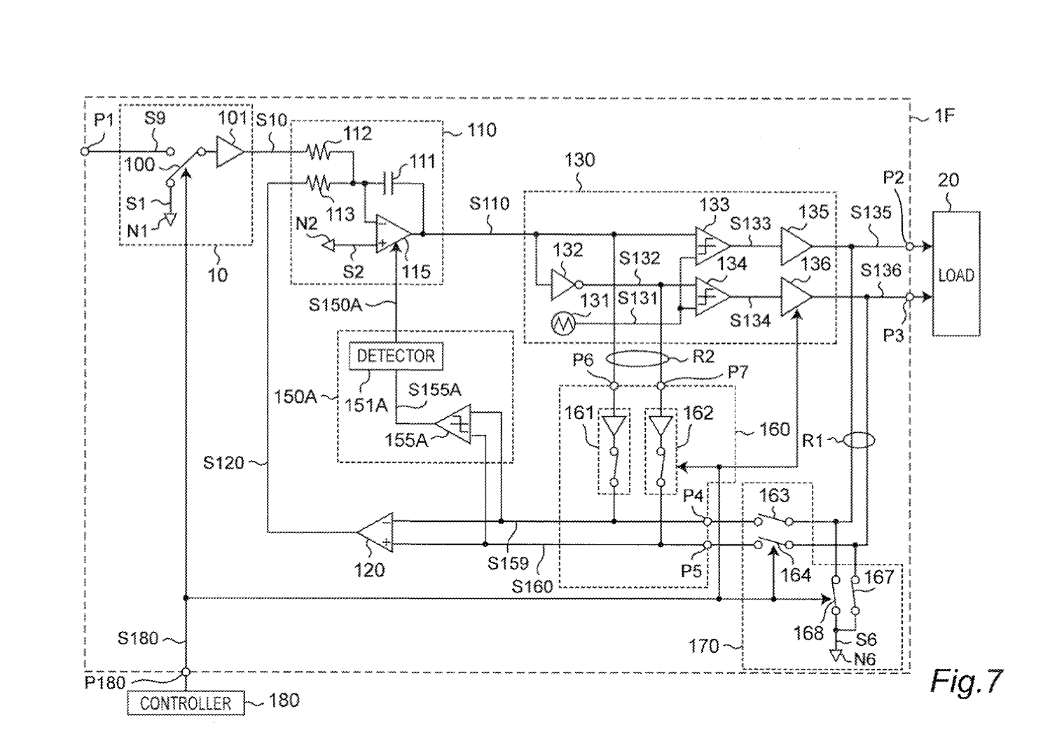

FIG. 7 is a block diagram of an electrical load drive device 1F according to a seventh embodiment of the invention. This electrical load drive device 1F differs from the electrical load drive device 1 according to the first embodiment of the invention in that offset correction signal generator 150 is changed to offset correction signal generator 150A of the second embodiment described above.

Other aspects of the configuration, operation, and effect of this embodiment are identical to the electrical load drive device 1 described above, and further description thereof is omitted below.

With this configuration, the electrical load drive device 1F can simplify the hardware or software configuration of the offset correction signal generator 150A compared with the offset correction signal generator 150 described above.

### Embodiment 8

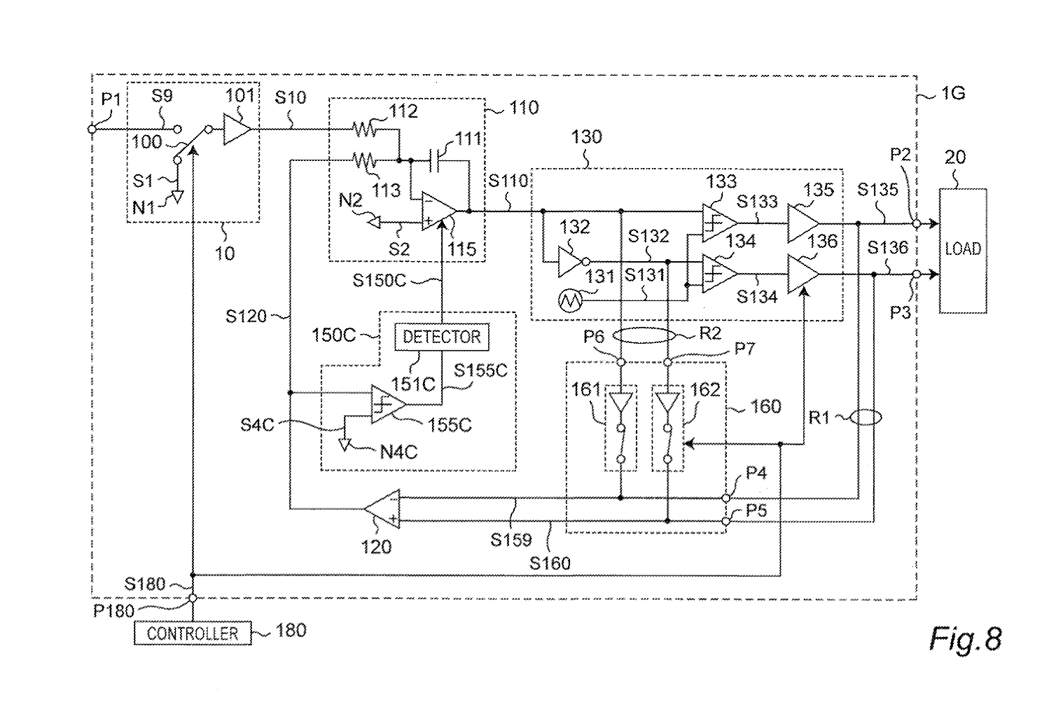

FIG. 8 is a block diagram of an electrical load drive device 1G according to an eighth embodiment of the invention. This electrical load drive device 1G differs from the electrical load drive device 1 according to the first embodiment of the invention in that offset correction signal generator 150 is changed to offset correction signal generator 150C, and the reverse-current suppressor 170 is omitted.

Other aspects of the configuration, operation, and effect of this embodiment are identical to the electrical load drive device 1 described above, and further description thereof is omitted below.

The offset correction signal generator 150C includes voltage node N4C, comparator 155C, and detector 151C. The offset correction signal generator 150C produces offset correction signal S150C for adjusting the integrated signal S110 so that the offset of feedback signal S120 decreases. The integrator 110 adjusts the integrated signal S110 based on the offset correction signal S150C.

In the offset correction signal generator 150C, the comparator 155C compares feedback signal S120 with the specific comparison voltage S4C at voltage node N4C, and outputs comparison result signal S155C. The detector 151C generates offset correction signal S150C based on comparison result signal S155C to reduce the offset between feedback signals S159, S160.

As a result, the electrical load drive device 1G can reduce the hardware or software configuration of the offset correction signal generator 150C compared with offset correction signal generator 150, and can simplify the hardware configuration of the reverse-current suppressor 170.

In this electrical load drive device 1G, the load drive signals S135, S136 of the electrical load drive device 1 must be high amplitude signals sufficiently capable of driving the load 20, and the feedback signals S159, S160 are therefore also high amplitude signals. As a result, the drive voltage of the electrical load drive device 1G is set high for the drivers 135 and 136, amplifiers 161 and 162, and signal attenuator 120, and set relatively low for other circuits. As a result, the electrical load drive device 1G can balance high amplitude output of the load drive signals S135, S136 with low power consumption.

The offset correction signal generator 150C receives a feedback signal S120 with lower amplitude than feedback signals S159, S160. As a result, the offset correction signal generator 150C can operate with a lower supply voltage than can the offset correction signal generator 150, can reduce power consumption in the offset correction state, and can reduce the circuit area.

### CONCLUSION

As described above, the input selector 10 and integrator 110 use a single-ended configuration for both input and output. However, a differential configuration could be used on at least the output of the input selector 10 and the input and output of the integrator 110. In this case the input and output of the inverter 132 are shorted (that is, the inverter 132 can be omitted), and the output of the signal attenuator 120 is a differential output. There are also two channels, the path from the integrator 110 to the load driver 130, and the path from the signal attenuator 120 to the integrator 110.

The output of the load driver 130 is differential above, but a single-ended configuration could be used. In this case, the inverter 132, comparator 134, driver 136, switch 164, switch 167, and amplifier 162 are omitted, paths R1, R2, and a single path from path selector 160 to the signal attenuator 120, and the input to the signal attenuator 120 is single-ended.

The offset correction signal generators 150, 150A, 150B described above may be rendered identically to offset correction signal generator 150C. Comparator 155C compares feedback signal S159 with the specific comparison voltage S4C at voltage node N4C, and outputs comparison result signal S155C. Based on comparison result signal S155C, the detector 151C generates the offset correction signal S150C to reduce the offset of the feedback signal S159.

Note that the signal attenuator 120 is inserted to the path from the output node of the path selector 160 to the feedback input node of the integrator 110, but could be inserted to path R1. In this case path R2 and the path from the signal attenuator 120 through the path selector 160 to the integrator 110 is a single channel, and the input and output of the path selector 160 are single-ended.

The path selector 160 could be configured to include amplifier 161 and omit amplifier 162. The amplifier 161 could amplify or attenuate the integrated signal S110. Because the feedback signals S159, S160 thus become low amplitude signals, the supply voltage of the electrical load drive device may be set high for the drivers 135 and 136 and the signal attenuator 120, and set relatively low for other circuits including amplifiers 161, 162 and difference signal generator 152. This enables further reducing power consumption.

As described above, by using a path selector 160 that selects path R1 or path R2, the electrical load drive device 1 according to the first embodiment of the invention can always form a closed loop through the path selector 160, signal attenuator 120, and integrator 110. More specifically, the path selector 160 selects path R1 when operation is controlled to a load drive state in which a load 20 is driven, and selects path R2 when controlled to the offset correction state denoting the state for correcting the offset of feedback signals S159, S160.

The electrical load drive device 1 according to the invention has a negative feedback path from the path selector 160 through the signal attenuator 120 to the integrator 110 in both the load drive state and offset correction state. As a result, the integrator 110 can continue operating without reconfiguring when operation switches from the load drive state to the offset correction state. As a result, a configuration for initializing the integrating capacitance 111, and an external input terminal for offset correction, can be omitted. A highly accurate offset correction operation can therefore be achieved, and the offset can be sufficiently reduced.

The embodiments described above are specific preferred embodiments of the invention, but the invention is not so limited and can be easily modified in many ways by one with ordinary skill in the related art using the technology of the invention described above.

### APPLICATION IN INDUSTRY

The invention can be used in an electrical load drive device.

The invention being thus described, it will be obvious that it may be varied in many ways. Such variations are not to be regarded as a departure from the spirit and scope of the invention, and all such modifications as would be obvious to one skilled in the art are intended to be included within the scope of the following claims.

1. An electrical load drive device comprising:
an input selector that selects one of an input signal and no signal, and outputs an input selection signal representing the selected signal;
an integrator that integrates the input selection signal and outputs an integrated signal;
a load driver that generates a load drive signal that drives the load, said load drive signal being prepared by pulse-width modulation and amplification of the integrated signal;
a first path that feeds back the load drive signal;
a second path that feeds back the integrated signal;
a path selector that selects one of the first path and the second path, and generates a first feedback signal based on the selected one of the load drive signal and the integrated signal; and
an offset correction signal generator that generates an offset correction signal for adjusting the integrated signal so that the offset of the first feedback signal decreases;
wherein the integrator adds and integrates the first feedback signal with the input selection signal, and adjusts the integrated signal based on the offset correction signal.

2. The electrical load drive device described in claim 1, wherein:
the path selector is controlled based on a control signal from a controller, said controller selecting a load drive state in which the first path is enabled to drive the load, and selecting an offset correction state in which the second path is enabled to correct the offset of the first feedback signal.

3. The electrical load drive device described in claim 2, wherein:
the input selector selects the input signal when the controller selects the load drive state, and selects no signal when the controller selects the offset correction state.

4. The electrical load drive device described in claim 2, wherein:
the load driver is set to a high impedance state when the controller selects the offset correction state.

5. The electrical load drive device described in claim 2, further comprising:
a reverse-current suppressor that suppresses reverse current flow to the first path of the integrated signal.

6. The electrical load drive device described in claim 5, wherein:
the reverse-current suppressor includes a first switch, said first switch isolating the first path when the controller selects the offset correction state.

7. The electrical load drive device described in claim 6, wherein:
the reverse-current suppressor includes a second switch, said second switch providing a specific voltage to the first path when the controller selects the offset correction state.

8. The electrical load drive device described in claim 6, wherein:
the reverse-current suppressor includes a resistor, said resistor suppressing the integrated signal from entering into the first path as a reverse current.

9. The electrical load drive device described in claim 2, wherein:
the path selector includes a switch, said switch isolating the second path when the controller selects the load drive state.

10. The electrical load drive device described in claim 1, further comprising:
a signal attenuator that attenuates the first feedback signal, and outputs the attenuated signal as a second feedback signal;
wherein the offset correction signal generator generates the offset correction signal so that the offset of at least one of the first feedback signal and the second feedback signal decreases, and
wherein the integrator adds and integrates the second feedback signal with the input selection signal.

11. The electrical load drive device described in claim 10, wherein:
the load driver includes an inverter that inverts the integrated signal, and
the load driver generates two load drive signals in two channels, one by pulse width modulation and amplification of the integrated signal, and the other by pulse width modulation and amplification of the inverted integrated signal;
the first path feeds back the two load drive signals in two channels;
the second path feeds back the integrated signal and the inverted integrated signal; and
the path selector generates the two first feedback signals in two channels based on the two load drive signals in two channels or the integrated signal and the inverted integrated signal.

12. The electrical load drive device described in claim 11, wherein:
the signal attenuator converts the two first feedback signals in two channels to a second feedback signal in a single channel.

13. The electrical load drive device described in claim 10, wherein:
the offset correction signal generator includes:
a difference signal generator that generates a difference signal representing a difference between the two first feedback signals in two channels;
a first comparator that compares the difference signal with a first predetermined value, and outputs a first comparison result signal; and
a detector that generates the offset correction signal based on the first comparison result signal so that the difference signal decreases.

14. The electrical load drive device described in claim 13,
wherein the offset correction signal generator compares the difference signal with a second predetermined value which is different from the first predetermined value, and outputs a second comparison result signal; and
wherein the detector generates the offset correction signal based on the first comparison result signal and the second comparison result signal.

15. The electrical load drive device described in claim 11, wherein:
the offset correction signal generator includes
a comparator that compares the two the first feedback signals in two channels and generates a comparison result signal, and
a detector that generates the offset correction signal so that the offset of the first feedback signals in the two channels decreases.

16. The electrical load drive device described in claim 1, wherein:
the offset correction signal generator includes
a comparator that compares the first feedback signal with a predetermined value and generates a comparison result signal, and
a detector that generates the offset correction signal based on the comparison result signal so that the offset decreases.

17. The electrical load drive device described in claim 16, wherein:
the comparator compares the second feedback signal with a predetermined value.

18. The electrical load drive device described in claim 1, wherein:
the load driver includes a triangular wave generator that produces a triangular wave signal,
a comparator that compares the integrated signal with the triangular wave signal and outputs a comparison result signal, and
a driver that amplifies the comparison result signal and outputs the load drive signal.

19. The electrical load drive device described in claim 1, wherein:
the path selector includes an amplifier that amplifies the integrated signal.
